(19) United States
(12) Patent Application Publication
(10) Pub. No.: US 2017/0166761 A1
(43) Pub. Date: Jun. 15, 2017

(54) ULTRAVIOLET-ABSORBING COATING COMPOSITION HAVING ENHANCED ABRASION RESISTANCE

(71) Applicant: Hyundai Motor Company, Seoul (KR)

(72) Inventors: Sang Young Kim, Hwaseong (KR); Ock Young Hwang, Daejeon (KR); Tae Hyun Kim, Daejeon (KR)

(21) Appl. No.: 15/220,998

(22) Filed: Jul. 27, 2016

(30) Foreign Application Priority Data
Dec. 11, 2015 (KR) 10-2015-0176892

(51) Int. Cl. C09D 5/32; C09D 183/04

(52) U.S. Cl. CPC C09D 5/32; C09D 183/04

(57) ABSTRACT

Disclosed is a coating composition for wet coating to block ultraviolet light radiation as being applied on a vehicle glass. The composition comprises: a binder including an amount of about 15 to 20% by weight of tetraethoxysilane (TEOS) and an amount of about 10 to 15% by weight of glycidoxypropyltrimethoxysilane (GPTS), an amount of about 20 to 35% by weight of an organic solvent, an amount of about 0.5 to 2% by weight of a curing agent, an amount of about 0.1 to 0.5% by weight of a leveling agent, an amount of about 10 to 40% by weight of a hydrophobically surface-treated inorganic nanosol, an amount of about 8 to 12% by weight of an inorganic ultraviolet blocking agent and an amount of about 1 to 3% by weight of a fluorescent whitening agent, all these % by weights based on the total weight of the coating composition.

Accordingly, the coating composition may be used as a vehicle glass coating agent due to substantially improved abrasion resistance and durability.

### CROSS-REFERENCE TO RELATED APPLICATION

This application claims under 35 U.S.C. §119(a) the benefit of priority to Korean Patent Application No. 10-2015-0176892 filed on Dec. 11, 2015, the entire contents of which are incorporated herein by reference.

### BACKGROUND

(a) Technical Field

The present invention relates to a coating composition. The coating composition may absorb ultraviolet light as being coated on a surface of glass and the like and may be used even under harsh conditions due to improved abrasion resistance.

(b) Background Art

Recently, the seriousness of ultraviolet light has emerged with depletion of the ozone layer and the like. Ultraviolet light may be classified into UVA having a wavelength of about 320 to 400 nm and UVB having a wavelength of about 280 to 320 nm. UVA has a low intensity due to long wavelength, but passes through the skin's epidermis and permeates deeply to the dermis and then damages fibrous tissues such as collagen or elastin. Accordingly, UVA has been known to cause skin aging, melasma, wrinkles, and freckles.

UVB is directly absorbed in DNAs of cells in the epidermal layers and causes damage to the DNAs. During repair of the damaged DNAs, inflammatory reaction occurs, resulting in skin redness and, more seriously, burning. In addition, repeated DNA damage also has been known to cause a cancer.

Accordingly, a research has been conducted on technologies for blocking ultraviolet light in various industries. In particular, an interest in such technologies has been increased in the vehicle field that is absolutely indispensable in modern life.

In the related arts, various methods for blocking ultraviolet light incident through car windows have been used.

For example, a method of adding an ultraviolet-absorbing material to glass in the process of producing the glass has been disclosed. However, an amount of added ultraviolet-absorbing material may not be increased because transparency of the glass should be secured.

In other example, a method of reflecting ultraviolet light using an ultraviolet interference filter has been introduced. According to this method, a multi-layer thin film including a plurality of layers having different refractive indexes may be coated on glass to reflect ultraviolet light by multiple interference. However, manufacturing cost is highly expensive and curved glass such as glass windows for vehicles may not be manufactured using this method.

In addition, a method for adhering an ultraviolet-absorbing film to glass windows has been reported. However, the film may cause problems associated with drivers' view due to low visible light transmittance and has drawbacks of low abrasion resistance and scratch resistance.

The drawbacks of the aforementioned methods may be serious, so that they may not be suitably applied to vehicles. Accordingly, currently, a method for forming a kind of coating film by applying an ultraviolet-absorbing composition to glass windows has been the most generally used.

Accordingly, the ultraviolet-absorbing composition may be required to have superior visible light transmittance and ultraviolet light absorption, and secure abrasion resistance to endure harsh conditions associated with operation of vehicles.

Korean Patent Publication Laid-open No. 10-2012-0039779 has disclosed an abrasion-resistant selective light-absorbing coating which may be prepared by adding an inorganic light-blocking agent to a binder consisting of an acrylic silicon emulsion and a silica nanosol. However, a coating film produced with the light-blocking coating may have a limitation in that it has a pencil hardness of about 5 H and thus may not have sufficient abrasion-resistance for use in glass windows of vehicles.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides a coating composition for absorbing ultraviolet light. The coating composition may have substantially improved ultraviolet absorption, durability and humidity resistance, and good abrasion resistance and scratch resistance.

We now provide an organic/inorganic hybrid binder obtained or obtainable by condensation polymerization of tetraethoxysilane (hereinafter, referred to as “TEOS”) with glycidoxypropyltrimethoxysilane (glycidoxypropyltrimethoxysilane, hereinafter, referred to “GPTS”), by using a hydrophobic inorganic nanosol surface-treated to improve abrasion resistance as a filler, and by using an inorganic ultraviolet blocking agent with superior durability and light resistance in combination therewith in order to use a fluorescent whitening agent preferably with low humidity resistance in as low an amount as possible.

In one aspect, the present invention provides a coating composition for absorbing ultraviolet with improved abrasion resistance. The coating composition may comprise an amount of about 25 to 35% by weight of a polysiloxane binder, an amount of about 10 to 40% by weight of an inorganic nanosol, an amount of about 20 to 35% by weight of an organic solvent, and an amount of about 8 to 12% by weight of an inorganic ultraviolet blocking agent. All these % by weights are based on the total weight of the coating composition, unless otherwise indicated herein.

The term “binder”, as used herein, refers to a resin or a polymeric material that may provide adhesion to components included in a matrix. The binder may be cured (polymerized) or partially cured upon curing process such as heating, UV radiation, electron beaming, chemical polymerization using additives and the like. Preferably, the binder of the present invention may be a polysiloxane-based binder that may comprise a functional group of organosilicon groups, such as Si—O—Si linkage. For example, the organosilicon group linkages may be included in the polysiloxane polymers by condensation at least one or more of silane monomers, for example, tetraethoxysilane (TEOS) and glycidoxypropyltrimethoxysilane (GPTS). Preferably, the binder according to the present invention generally refers to a polysiloxane-based binder.

In particular, the polysiloxane binder may comprise an amount of about 15 to 20% by weight of tetraethoxysilane (TEOS) based on the total weight of the coating composition and an amount of about 10 to 15% by weight of glycidoxypropyltrimethoxysilane (GPTS) based on the total weight of the coating composition. In particular aspects, tetraethoxysilane (TEOS) and glycidoxypropyltrimethoxysilane (GPTS) may be condensed to form the polysiloxane binder.

The inorganic nanosol suitably may be hydrophobically surface-modified with an organosilane compound.

The term “hydrophobic” as used herein refers to a chemical property of repelling or avoiding water molecules. As such, the “hydrophobically modified” compound or material may be modified to include water-repelling or hydrophobic groups on a surface area or interacting area that is exposed to the water or aqueous solution. For instance, the hydrophobically modification may include attaching chemical groups such as alkyl silane, acryl silane, epoxy silane, vinyl silane or amino silane.

The inorganic nanosol may include one or more of inorganic oxide sols selected from the group consisting of a silica sol, an alumina sol, a titania sol, a zirconia sol and a ceria sol.

The term “sol” as used herein may be a suspension or dispersion of solid particles such as precipitation, colloids, or the like in a continuous liquid medium such as water or an organic solvent. The sol may contain substantial amount of solid content, for example, greater than about 10 wt % based on the total weight of the coating composition, greater than about 20 wt % based on the total weight of the coating composition, greater than about 30 wt % based on the total weight of the coating composition, or particularly of about 30 to 40% by weight based on the total weight of the coating composition, such that the sole may remain reduced fluidity or increased density. In addition, the term “nanosol” refers to a sol (solution) that may comprise particles or colloids having a size in nanometer scale, for example, of about 1 nm to 999 nm, of about 1 nm to 900 nm, of about 1 nm to 800 nm, of about 1 nm to 700 nm, of about 1 nm to 600 nm, of about 1 nm to 500 nm, of about 1 nm to 400 nm of about 1 nm to 300 nm, of about 1 nm to 200 nm, of about 1 nm to 100 nm or the like. The organosilane compound may include one or more selected from the group consisting of alkyl silane, acryl silane, epoxy silane, vinyl silane and amino silane.

The organic solvent may include one or more of ketone, ether and alcohol.

The inorganic ultraviolet blocking agent may include one or more selected from the group consisting of cerium oxide (CeO₂), zinc oxide (ZnO), titanium dioxide (TiO₂), ferric oxide (Fe₂O₃) and tungsten trioxide (WO₃).

The coating composition may further include an amount of about 0.5 to 2% by weight of a curing agent, an amount of about 0.1 to 0.5% by weight of a leveling agent, and an amount of about 1 to 3% by weight of a fluorescent whitening agent all said % by weight based on the total weight of the coating composition.

The fluorescent whitening agent may include one or more selected from the group consisting of stilbene, coumarin, naphthalimide and benzoxazole.

Further provided herein is the coating composition that may consist essentially of, essentially consist of, or consist of the components as described herein. For instance, the coating composition may consist essentially of, essentially consist of, or consist of: an amount of about 25 to 35% by weight of a polysiloxane binder; an amount of about 10 to 40% by weight of an inorganic nanosol; an amount of about 20 to 35% by weight of an organic solvent; and an amount of about 8 to 12% by weight of an inorganic ultraviolet blocking agent, all these % by weights based on the total weight of the coating composition.

In addition, the coating composition may consist essentially of, essentially consist of, or consist of: an amount of about 25 to 35% by weight of a polysiloxane binder; an amount of about 10 to 40% by weight of an inorganic nanosol; an amount of about 20 to 35% by weight of an organic solvent; an amount of about 8 to 12% by weight of an inorganic ultraviolet blocking agent; an amount of about 0.5 to 2% by weight of a curing agent; an amount of about 0.1 to 0.5% by weight of a leveling agent; and an amount of about 1 to 3% by weight of a fluorescent whitening agent, all these % by weight based on the total weight of the coating composition.

Still further, provided is a vehicle part that may comprise the coating composition as described herein. For example, the vehicle part may be a glass component of the vehicle.

Additionally, provided is a vehicle that may comprise a vehicle part including the coating composition as described herein.

Other aspects embodiments of the invention are discussed infra.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The coating composition of the present invention may absorb ultraviolet light. The coating composition may include an amount of about 25 to 35% by weight of a polysiloxane binder containing tetraethoxysilane (TEOS) and glycidoxypropyltrimethoxysilane (GPTS), an amount of about 10 to 40% by weight of an inorganic nanosol, an amount of about 20 to 35% by weight of an organic solvent and an amount of about 8 to 12% by weight of an inorganic ultraviolet blocking agent.

The polysiloxane binder may be selected in consideration of effects on basic physical properties such as abrasion resistance and scratch resistance of a coating film formed using the composition as well as miscibility thereof with the ultraviolet blocking agent. In particular, the coating film may not reduce visible light transmittance.

Accordingly, the coating composition may include an amount of about 15 to 20% by weight of tetraethoxysilane (TEOS) in combination 10 to 15% by weight of glycidoxypropyltrimethoxysilane (GPTS) as the polysiloxane binder. In particular, TEOS and GPTS may be polymerized by condensation reaction.

TEOS may facilitate formation of silica bonds and silanols via hydrolysis and condensation polymerization, and all remaining silanols may be converted to silica bonds during curing process to form the coating film. Accordingly, curing density may be substantially improved, strength and abrasion resistance of the coating film finally obtained may be significantly improved, and cracks in the coating film may be prevented due to superior heat resistance and durability.

TEOS may be included in an amount of about 15 to 20% by weight, based on the weight of the composition. When the content of TEOS is less than about 15% by weight, a content of an inorganic substance in the binder ingredient constituting the coating film may be decreased, an effect of increasing curing density may be insufficient, and abrasion resistance and hardness may be thus reduced. When the content of TEOS is greater than about 20% by weight, humidity resistance may be degraded by residual silanols that do not participate in condensation polymerization during curing, and adhesivity may be reduced or cracks may occur by stress resulting from curing contraction.

GPTS, as used herein, may be a coupling agent which may improve adhesivity of the coating film to inorganic surfaces of glass windows. For instance, GPTS may substantially improve adhesivity of the coating to glass surfaces due to its reactivity to organic and inorganic materials.

GPTS may be included in an amount of about 10 to 15% by weight, based on the weight of the composition. When the content of GPTS is less than about 10% by weight, humidity resistance may be reduced and adhesivity to glass base materials may deteriorate. When the content of GPTS is greater than about 15% by weight, the content of the organic substance in the coating film may be increased and abrasion resistance of the coating film may thus be reduced.

The inorganic nanosol may improve mechanical properties such as abrasion resistance and scratch resistance of the coating film formed using the composition as well as ultraviolet and infrared absorption thereof.

In particular, the inorganic nanosol may be a hydrophobically surface-treated inorganic nanosol.

The inorganic nanosol may be a silica, alumina, titania or zirconia sol, or a metal oxide which may absorb an infrared- or ultraviolet light. For example, the metal oxide sol may include an antimony tin oxide (ATO), indium tin oxide (ITO), cesium tungsten oxide, zinc oxide or ceria sol.

Since the inorganic nanosol includes hydroxyl groups on particle surfaces thereof, nonpolar organic solvents or organic substances may not be sufficiently mixed or react with the nanosols such that the nanosols may not be used as an organic/inorganic hybrid. Accordingly, the surface of inorganic nanosol may be suitably hydrophobically modified so as to improve reactivity, miscibility and dispersibility with organic substances.

For this purpose, the inorganic nanosol may be surface-treated with an organosilane compound such as alkyl silane, acryl silane, epoxy silane, vinyl silane or amino silane. For example, the surface of inorganic nanosol may be hydrophobically modified by steps comprising: 1) dispersing the inorganic nanosol in water, 2) removing water from the water-dispersed inorganic nanosol and then adding the water-removed inorganic nanosol to an organic solvent, and 3) adding the organosilane compound thereto to proceed with hydrolysis.

The inorganic nanosol may be included in an amount of about 10 to 40% by weight based on the total weight of the coating composition. When the content of inorganic nanosol is less than about 10% by weight, the inorganic nanosol may not have a great effect on improvement in abrasion resistance and scratch resistance of the coating film. When the content of inorganic nanosol is greater than about 40% by weight, the binder ingredient in the coating film may not be insufficient, the coating film may not be formed sufficiently and adhesivity may be thus degraded.

In addition, the inorganic nanosol may have a particle size of about 10 to 100 nm and a solid content of about 30 to 40% by weight. It would appreciated that ASAHIDENKA AT-30A having a solid content of 30% by weight may provide a suitable inorganic nanosol that may have superior performance upon use.

The organic solvent as used herein may disperse respective ingredients of the composition. In particular, because the polysiloxane binder is prepared by condensation polymerization of an organosilane compound such as tetraethoxysilane (TEOS) or glycidoxypropyltrimethoxysilane (GPTS), these ingredients may agglomerate when dispersed in water. Accordingly, an organic solvent may be preferably used.

The organic solvent may include a polar organic solvent such as ketone, ether, alcohol or mixtures thereof.

The organic solvent may influence the thickness of the finally obtained coating film. The organic solvent may be included in an amount ranging from about 20 to about 35% by weight based on the total weight of the coating composition. When the content of organic solvent is less than about 20% by weight, the solid content of binder may be increased and the surface of the coating film may crack. When the content of the organic solvent is greater than about 35% by weight, the thickness of the coating film may be decreased and ultraviolet blocking performance may thus be reduced.

In addition, the organic solvent may be the same as the organic solvent used for surface treatment of the inorganic nanosol described above.

The coating composition according to the present invention may include an inorganic ultraviolet blocking agent as an ultraviolet-blocking substance. The ultraviolet blocking agent may include inorganic ultraviolet blocking agents such as cerium oxide (CeO₂), zinc oxide (ZnO), titanium dioxide (TiO₂), ferric oxide (Fe₂O₃) and tungsten trioxide (WO₃), and organic ultraviolet blocking agents such as benzotriazole (C₆H₅N₃), benzophenone ((C6H₅)₂O₂Na), cyclic imino ester, arylated cyanoacrylate and triazine.

However, the inorganic ultraviolet blocking agent may be preferably used because the organic ultraviolet blocking agent may have less discoloration resistance after coating the composition.

Accordingly, the ultraviolet blocking agent in the coating composition according to the present invention may include cerium oxide (CeO₂), zinc oxide (ZnO), titanium dioxide (TiO₂), ferric oxide (Fe₂O₃) or tungsten trioxide (WO₃) may be used alone or as a mixture thereof.

It would be appreciated that CeO₂—ZrO₂-based CZ-30A (Nissan Chemical Industries, Ltd.), ceria sol-based CE-40BL (Nissan Chemical Industries, Ltd.) and Colloidal Ceria-AC (Nyacol) may provide a suitable ultraviolet blocking agent according to the present invention.

In particular, particles of the inorganic ultraviolet blocking agent are surface-treated with the silane coupling agent, miscibility with the polysiloxane binder may be improved and dispersibility may thus be improved. Accordingly, visible light transmittance of the coating film may be improved, dispersibility of ultraviolet blocking agent particles may be substantially improved and an amount of used ultraviolet blocking agent may thus be reduced.

The inorganic ultraviolet blocking agent may be included in an amount of about 8 to 12% by weight based on the total weight of the coating composition. When the content of inorganic ultraviolet blocking agent is less than about 8% by weight, ultraviolet blocking efficiency may be significantly reduced. When the content thereof is greater than about 12% by weight, no great influence may be obtained on an increase in ultraviolet blocking effect.

The coating composition according to the present invention may further include an amount of about 0.5 to 2% by weight of a curing agent, an amount of about 0.1 to 0.5% by weight of a leveling agent and an amount of about 1 to 3% by weight of a fluorescent whitening agent.

The fluorescent whitening agent may be a dye which may absorb ultraviolet light and emit fluorescent light at a wavelength of about 430 nm. The fluorescent whitening agent may include stilbene, coumarin, naphthalimide, benzoxazole or as mixtures thereof. In particular, these whitening agents may have high whiteness, high solubility in organic solvents, and superior thermal stability, chemical stability and miscibility with the polysiloxane binder.

The fluorescent whitening agent may be included in an amount of about 1 to 3% by weight based on the total weight of the coating composition. When the content of fluorescent whitening agent is less than about 1% by weight, desired ultraviolet blocking efficiency may not be obtained and when the content thereof is of about 3% by weight or greater, humidity resistance of glass coating film may be decreased.

The leveling agent may improve leveling property, and decrease surface tension and slipping property to the coating film surface. Particularly, the leveling agent may prevent defects, such as pin holes, cratering and mottling, possibly occurring on the coating film. When the leveling agent is added, flowability of the coating film may be improved and such defects may thus be controlled.

When the leveling agent is added in an amount of less than about 0.1% by weight, based on the total weight of the coating composition, the above described effects may be obtained, and when the leveling agent is added in an amount greater than about 0.5% by weight, abrasion resistance, humidity resistance and durability may deteriorate. Thus, preferably, the leveling agent may be included in an amount of about 0.1 to 0.5% by weight based on the total weight of the coating composition.

The coating composition of the present invention may be applied to form a coating film by an ordinary wet coating method such as flow coating, spin coating, bar coating, dip coating or spray coating. For example, flow coating may be preferably used for a glass of a vehicle having a curved surface.

### EXAMPLE

Hereinafter, the present invention will be described in more detail with reference to the following examples and comparative examples. However, these examples are provided only for illustration of the present invention and are not to be construed as limiting the scope of the invention.

### Example 1

### Preparation of Abrasion-Resistant Ultraviolet-Absorbing Glass Coating Composition

### (Step 1)

15% by weight of tetraethoxysilane was mixed with 10% by weight of glycidoxypropyltrimethoxysilane (glycidoxypropyltrimethoxysilane), 6.3% by weight of ethanol (ethyl alcohol) was added thereto and the resulting mixture was then stirred for 10 minutes. 9.5% by weight of 0.1N hydrochloric acid (0.1N HCl) was added as a polymerization catalyst and the resulting mixture was then mixed for 2 hours and aged for 8 hours.

### (Step 2)

25.0% by weight of a hydrophobically surface-modified silica sol and 21.0% by weight of isopropyl alcohol were added to the silane hydrolysate obtained by the method described above, and 1.0% by weight of a curing agent and 0.2% by weight of a leveling agent were then added thereto, followed by mixing for 10 minutes.

### (Step 3)

10.0% by weight of an inorganic ultraviolet blocking agent (product name: ADK STAB AO-80, Adeka, Japan) and 2.0% by weight of a fluorescent whitening agent (product name: ADK STAB LA-62, Adeka, Japan) were added to the solution obtained in Step 2, followed by stirring for 1 hour, to obtain an ultraviolet-absorbing glass coating agent.

### Examples 2, 3, 4, 5 and 6

Ultraviolet-absorbing glass coating compositions were prepared in the same manner as in Example 1, except that amounts of used binder were different, as shown in the following Table 1.

TABLE 1

| | | Examples | | | | | |
|---|---|---|---|---|---|---|---|
| Items | | 1 | 2 | 3 | 4 | 5 | 6 |
| Binder | TEOS | 15.0 | 15.0 | 20.0 | 20.0 | 15.0 | 15.0 |
| | GPTS | 10.0 | 15.0 | 10.0 | 15.0 | 15.0 | 15.0 |
| | EtOH | 6.3 | 5.8 | 5.8 | 6.2 | 7.2 | 6.0 |
| | Polymerization | 9.5 | 9.0 | 9.0 | 9.6 | 10.6 | 7.5 |
| | catalyst | | | | | | |
| Organic | IPA | 21.0 | 22.0 | 22.0 | 21.0 | 24.0 | 18.3 |
| solvent | | | | | | | |
| Blocking | Inorganic | 10.0 | 10.0 | 10.0 | 10.0 | 5.0 | 15.0 |
| agent | blocking agent | | | | | | |
| | Fluorescent | 2.0 | 2.0 | 2.0 | 2.0 | 2.0 | 2.0 |
| | whitening agent | | | | | | |
| Additives | Silica sol | 25.0 | 20.0 | 20.0 | 15.0 | 20.0 | 20.0 |
| | Leveling agent | 0.2 | 0.2 | 0.2 | 0.2 | 0.2 | 0.2 |
| | Curing agent | 1.0 | 1.0 | 1.0 | 1.0 | 1.0 | 1.0 |

| | | | | | | |
|---|---|---|---|---|---|---|
| Total | 100.0 | 100.0 | 100.0 | 100.0 | 100.0 | 100.0 |

### Comparative Example 1

An ultraviolet-absorbing glass coating composition was prepared in the same manner as in Example 1, except that mix ratios of Comparative Example 1 were different from those of Example 1, as shown in Table 2 below.

### Comparative Examples 2, 3, 4, 5 and 6

Ultraviolet-absorbing glass coating compositions were prepared in the same manner as in Comparative Example 1, except that amounts of the binder, solvent and polymerization catalyst and an amount of silica sol as an additive, of Comparative Examples 2, 3, 4, 5 and 6 were different from those of Comparative Example 1, as shown in Table 2 below.

### Comparative Example 7

Comparative Example 7 used Hicool® 500 (DO Corporation)as an IR/UV blocking product.

TABLE 2

| | | Comparative Examples | | | | | | |
|---|---|---|---|---|---|---|---|---|
| Items | | 1 | 2 | 3 | 4 | 5 | 6 | 7 |
| Binder | TEOS | 5.0 | 10.0 | 15.0 | 25.0 | 15.0 | 15.0 | Hicool ® 500 |
| | GPTS | 5.0 | 10.0 | 5.0 | 20.0 | 10.0 | 10.0 | available |
| | EtOH | 5.3 | 5.3 | 5.8 | 4.8 | 6.3 | 6.3 | from DO |
| | Polymerization | 8.5 | 9.0 | 9.5 | 8.0 | 9.5 | 9.5 | corporation |
| | catalyst | | | | | | | |
| Organic | IPA | 23.0 | 22.5 | 21.5 | 19.0 | 21.0 | 21.0 | |
| solvent | | | | | | | | |
| Blocking | Inorganic | 10.0 | 10.0 | 10.0 | 10.0 | 5.0 | 15.0 | |
| agent | blocking agent | | | | | | | |
| | Fluorescent | 2.0 | 2.0 | 2.0 | 2.0 | 2.0 | 2.0 | |
| | whitening agent | | | | | | | |
| Additives | Silica sol | 40.0 | 30.0 | 30.0 | 10.0 | 30.0 | 20.0 | |
| | Leveling agent | 0.2 | 0.2 | 0.2 | 0.2 | 0.2 | 0.2 | |
| | Curing agent | 1.0 | 1.0 | 1.0 | 1.0 | 1.0 | 1.0 | |

| | | | | | | |
|---|---|---|---|---|---|---|
| Total | 100.0 | 100.0 | 100.0 | 100.0 | 100.0 | 100.0 |

Respective samples according to Examples 1 to 6 and Comparative Examples 1 to 7 were tested as follows and results thus obtained are shown.

### Test Example 1

### (1) States of Films After Curing

After films were cured in a drying oven at a temperature of 120° C. for 60 minutes and were then maintained at room temperature, in a case where neither cracks nor bubbles were observed by the naked eye, the state was marked with “∘”, in a case where cracks were observed in a thick part of the film, the state was marked with “Δ”, and in a case where cracks occurred to the inside of the film, or bubbles spread over the entire surface thereof and the film was not clear, the state was marked with “x”.

### (2) Optical Performance

Optical performance evaluation was performed in accordance with KS L 2514 standard method and transmittance was calculated. Specimens were prepared by cutting glass coated on slide glass, or a 100 mm×100 mm coated plate glass, and light transmittance in a wavelength region ranging from 300 nm to 2,500 nm was measured using a UV/VIS/NIR spectrophotometer (V-670) as measurement equipment. Transmittance in an ultraviolet region was obtained as an average of transmittance values measured three times at a wavelength of 300 nm to 380 nm, transmittance in a visible region was obtained as an average of transmittance values measured three times at 380 nm to 780 nm, and transmittance in an infrared region was obtained as an average of transmittance values measured three times at a wavelength of 780 nm to 2,500 nm.

### (3) Pencil Hardness

Pencil hardness was obtained as an average of values obtained by measuring three times under a load of 9.8 N, based on KS M ISO 15184.

### (4) Abrasion Resistance Test

Abrasion resistance test was performed in accordance with KS L 2007:2008 standard test. Specifically, abrasion resistance of specimens before abrasion was measured three times using a haze meter, an average of the three values was calculated, a load of 4.9N was applied to each abrasion wheel using a Taber abrasion tester, and the specimens were abraded by rotating 500 times at a rate of 75 rpm. After abrasion, abrasion resistance of the specimens was measured three times using the haze meter, an average of the three values was calculated and a haze resulting from abrasion was obtained by subtracting the average before abrasion from the average after abrasion.

### (5) Humidity Resistance Test

Humidity resistance test was performed in accordance with KSL 2007:2008. Specifically, 300 mm×300 mm coated plate glass specimens were vertically put in a constant temperature and constant humidity chamber set to a temperature of 50° C. and a relative humidity of 95%, maintained for 2 weeks and then taken out. At this time, discoloration, bubbling and the like were observed by the naked eye. As a result, in a case where the specimen did not get damp and was clear, it was marked with “∘”, in a case where the specimen got slightly damp, it was marked with “Δ”, and in a case where the coating solution was released and stained, or the film was peeled off and became hazy, it was marked with “x”.

Results obtained by the test are shown in Table 3.

TABLE 3

| | Examples | | | | | | Comparative Examples | | | | | | |
|---|---|---|---|---|---|---|---|---|---|---|---|---|---|
| | 1 | 2 | 3 | 4 | 5 | 6 | 1 | 2 | 3 | 4 | 5 | 6 | 7 |
| State of film | ∘ | ∘ | ∘ | ∘ | ∘ | ∘ | x | x | x | x | ∘ | ∘ | ∘ |
| Ultraviolet | 99.8 | 99.6 | 99.8 | 99.7 | 95.7 | 99.8 | — | — | — | — | 95.5 | 99.6 | 92.1 |
| blocking rate | | | | | | | | | | | | | |
| (%) | | | | | | | | | | | | | |
| Visible | 83.5 | 82.9 | 82.1 | 83.2 | 84.2 | 80.2 | — | — | — | — | 84.3 | 80.5 | 80.1 |
| transmittance | | | | | | | | | | | | | |
| (%) | | | | | | | | | | | | | |
| Pencil | 9 | 9 | 9 | 7 | 9 | 9 | — | — | — | — | 9 | 9 | 5 |
| hardness (H) | | | | | | | | | | | | | |
| Abrasion | 3.4 | 11.0 | 3.8 | 28.1 | 23.8 | 20.8 | — | — | — | — | 3.7 | 9.8 | Detachment |
| resistance | | | | | | | | | | | | | of film |
| haze (%) | | | | | | | | | | | | | |
| Moisture | ∘ | ∘ | ∘ | ∘ | ∘ | ∘ | — | — | — | — | ∘ | ∘ | ∘ |
| resistance | | | | | | | | | | | | | |

* In Comparative Examples 1, 2, 3 and 4, performance evaluation was impossible because the film cracked and was thus not formed.
* In Comparative Example 7, the film was totally peeled off and detached after 500× abrasion resistance testing.

As can be seen from Table 3 above, the abrasion-resistant ultraviolet-absorbing glass coating composition according to the present invention was significantly excellent, as compared to the conventionally commercially available product (Comparative Example 7: Hicool 500) in terms of abrasion resistance as well as ultraviolet blocking rate and visible transmittance. In addition, in Examples 1 to 6, the best effects were obtained when the binder content of the abrasion-resistant ultraviolet-absorbing glass coating agent was 25 to 35% by weight in consideration of the total weight of TEOS and GPTS. When the binder content was equal to or less than 25% by weight, or greater than 35% by weight, the films cracked and thus were not formed well.

In the present invention, an inorganic blocking agent and a fluorescent whitening agent may be preferably used together in order to obtain an ultraviolet-absorbing glass coating agent which may improve ultraviolet blocking rate, avoid deterioration in visible light transmittance and secure excellent abrasion resistance and durability. An inorganic blocking agent may be more preferable than an organic blocking agent in view of durability. In addition, it may be very important to make an amount of used fluorescent whitening agent as low as possible because the fluorescent whitening agent may be closely related to abrasion resistance and humidity resistance of the coating agent. As shown in the results above, when the inorganic blocking agent was included an amount of 10% by weight, based on the total amount of the coating composition, the best results were obtained. When the inorganic blocking agent was added in an amount greater than the level defined above, visible light transmittance was reduced without any influence on improvement in ultraviolet blocking rate.

The ultraviolet-absorbing glass coating composition according to the present invention, when used for vehicle glass, may suitably protect humans from harmful ultraviolet light, maintain a pleasant indoor environment, be economically efficient as an alternative to tinting films due to excellent resistance to weather condition and abrasion, and be thus highly marketable in the future. In addition, the coating composition may be suitably used instead of films in terms of recycling of vehicle glass and may exhibit good marketability.

The present invention has the aforementioned features and thus has the following effects.

The ultraviolet-absorbing coating composition according to the present invention may not obstruct drivers' view due to high visible transmittance.

In addition, the ultraviolet-absorbing coating composition according to the present invention may be highly effective in blocking ultraviolet light, thus protecting drivers from ultraviolet light and maintaining a pleasant indoor environment.

In addition, the ultraviolet-absorbing coating composition according to the present invention may maintain its functions even under harsh conditions owing to excellent durability such as abrasion resistance.

The effects of the present invention are not limited to those set forth above. It should be understood that the effects of the present invention include all the effects that can be inferred from the foregoing description.

The description made above is provided only for illustration of technical spirit of the present patent and it will be appreciated by those skilled in the art that a variety of changes and modifications may be made in these embodiments without departing from the principles and spirit of the invention.

In addition, embodiments disclosed in the present invention are provided only for illustration of the present invention and are not to be construed as limiting the scope of the invention.

Therefore, the protection right of the present patent should be interpreted in light of the claims, and it should be interpreted that all technical features that fall within the scope equivalent thereto are incorporated into the scope of the patent right.

What is claimed is:

1. A coating composition comprising:
an amount of about 25 to 35% by weight of a polysiloxane binder;
an amount of about 10 to 40% by weight of an inorganic nanosol;
an amount of about 20 to 35% by weight of an organic solvent; and
an amount of about 8 to 12% by weight of an inorganic ultraviolet blocking agent,
all the % by weights based on the total weight of the coating composition.

2. The coating composition of claim 1, wherein the polysiloxane binder comprises: an amount of about 15 to 20% by weight of tetraethoxysilane (TEOS) and an amount of about 10 to 15% by weight of glycidoxypropyltrimethoxysilane (GPTS), based on the total amount of the coating composition,
wherein tetraethoxysilane (TEOS) and glycidoxypropyltrimethoxysilane (GPTS) are condensed to form the polysiloxane binder.

3. The coating composition of claim 1, wherein the inorganic nanosol is hydrophobically surface-modified with an organosilane compound.

4. The coating composition of claim 3, wherein the inorganic nanosol comprises one or more of inorganic oxide sols selected from the group consisting of a silica sol, an alumina sol, a titania sol, a zirconia sol and a ceria sol.

5. The coating composition of claim 3, wherein the organosilane compound comprises one or more selected from the group consisting of alkyl silane, acryl silane, epoxy silane, vinyl silane and amino silane.

6. The coating composition of claim 1, wherein the organic solvent comprises one or more of ketone, ether and alcohol.

7. The coating composition of claim 1, wherein the inorganic ultraviolet blocking agent comprises one or more selected from the group consisting of cerium oxide (CeO₂), zinc oxide (ZnO), titanium dioxide (TiO₂), ferric oxide (Fe₂O₃) and tungsten trioxide (WO₃).

8. The coating composition of claim 1, further comprising:
an amount of about 0.5 to 2% by weight of a curing agent;
an amount of about 0.1 to 0.5% by weight of a leveling agent; and
an amount of about 1 to 3% by weight of a fluorescent whitening agent,
all the % by weights based on the total weight of the coating composition.

9. The coating composition of claim 8, wherein the fluorescent whitening agent comprises one or more selected from the group consisting of stilbene, coumarin, naphthalimide and benzoxazole.

10. The coating composition of claim 1, consisting essentially of:
an amount of about 25 to 35% by weight of a polysiloxane binder;
an amount of about 10 to 40% by weight of an inorganic nanosol;
an amount of about 20 to 35% by weight of an organic solvent; and
an amount of about 8 to 12% by weight of an inorganic ultraviolet blocking agent,
all the % by weights based on the total weight of the coating composition.

11. The coating composition of claim 1, consisting essentially of:
an amount of about 25 to 35% by weight of a polysiloxane binder;
an amount of about 10 to 40% by weight of an inorganic nanosol;
an amount of about 20 to 35% by weight of an organic solvent;
an amount of about 8 to 12% by weight of an inorganic ultraviolet blocking agent;
an amount of about 0.5 to 2% by weight of a curing agent;
an amount of about 0.1 to 0.5% by weight of a leveling agent; and
an amount of about 1 to 3% by weight of a fluorescent whitening agent,
all the % by weights based on the total weight of the coating composition.

12. A vehicle part that comprises a coating composition of claim 1.

13. A vehicle that comprises a vehicle part of claim 12.
